(19) United States
(12) Patent Application Publication
(10) Pub. No.: US 2017/0011415 A1
(43) Pub. Date: Jan. 12, 2017

(54) SYSTEM AND METHOD FOR GENERATING COUPONS BASED ON SHOPPING LISTS

(71) Applicant: Aintu Inc., San Jose, CA (US)

(72) Inventor: Arthur Vaysman, San Jose, CA (US)

(21) Appl. No.: 15/204,966

(22) Filed: Jul. 7, 2016

Related U.S. Application Data
(60) Provisional application No. 62/189,214, filed on Jul. 7, 2015.

(51) Int. Cl. G06Q 30/02

(52) U.S. Cl. CPC G06Q 30/0224; G06Q 30/0267; G06Q 30/0261

(57) ABSTRACT

A method for a server to generate coupons is provided. The method uses techniques to identify products on shopping lists of consumer in real time, information on the products is then shared with manufacturers, who are able to generate highly targeted coupons or promotional offers which are delivered to the consumer's in real time.

### FIELD

Embodiments of the present invention relate to methods and systems generating coupons

### BACKGROUND OF THE INVENTION

Advertisers (product manufacturers or service providers) issue and distribute coupons to encourage customers to purchase their products or to purchase products and services from them. With proliferation of mobile devices, increasing numbers of coupons are created for and distributed by mobile devices.

Because coupons are traditionally created, distributed, and most importantly redeemed in printed form—typically by a Point of Sale (POS) systems capable of scanning them, coupons in electronic form are not accepted by Brick and Mortar (BM) retailers as most existing POS systems are unable to receive coupon information from a mobile device.

### SUMMARY OF THE INVENTION

This invention offers a system and method for advertisers to create and distribute text or multi-media based hyper-targeted, personalized electronic offers and coupons which can be accepted and redeemed by BM businesses in electronic form regardless of the capabilities of their existing POS system.

Furthermore, the system allows manufacturers to create unique, identifiable, and traceable coupons which can be used to launch and run self-tuning marketing campaigns designed to meet various business objectives.

The invented system takes advantage of proliferation of mobile devices, their network connectivity, ability to install new applications, digital footprints left by consumers, and the fact that electronic coupon redemption by BM businesses is done in proximity to a customer.

### BRIEF DESCRIPTION OF THE FIGURES

FIG. 1 shows a deployment drawing in accordance with one embodiment of the invention

FIG. 2 shows the use cases for the DCPMS, in accordance with one embodiment of the invention.

FIG. 3 shows the use cases for coupon generation, in accordance with one embodiment of the invention.

FIG. 4 shows the use cases for coupon clipping and publishing in accordance with one embodiment of the invention.

FIG. 5 shows a coupon query Q1, in accordance with one embodiment of the invention.

FIG. 6 shows the use cases for the customer coupon app, in accordance with one embodiment of the invention.

FIGS. 7a-b shows a Publisher publishing media on a Customer node, in accordance with one embodiment of the invention.

FIG. 8 shows a flowchart for processing a coupon clipping notification, in accordance with one embodiment of the invention.

FIG. 9A shows the use cases for coupon redemption by the customer coupon app, in accordance with one embodiment of the invention.

FIG. 9B shows the use cases for coupon redemption by the retailer coupon app, in accordance with one embodiment of the invention.

FIG. 10 shows an example of published coupon, in accordance with one embodiment of the invention.

FIG. 11 shows the published coupon of FIG. 10 in magnified view, in accordance with one embodiment of the invention.

FIG. 12 shows an example of a report to an Advertiser, in accordance with one embodiment of the invention.

FIG. 13 shows a high-level block diagram of hardware for implementing the DCPMS, in accordance with one embodiment of the invention.

### DETAILED DESCRIPTION OF THE INVENTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block or flow diagram form only in order to avoid obscuring the invention. Accommodate

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to the details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

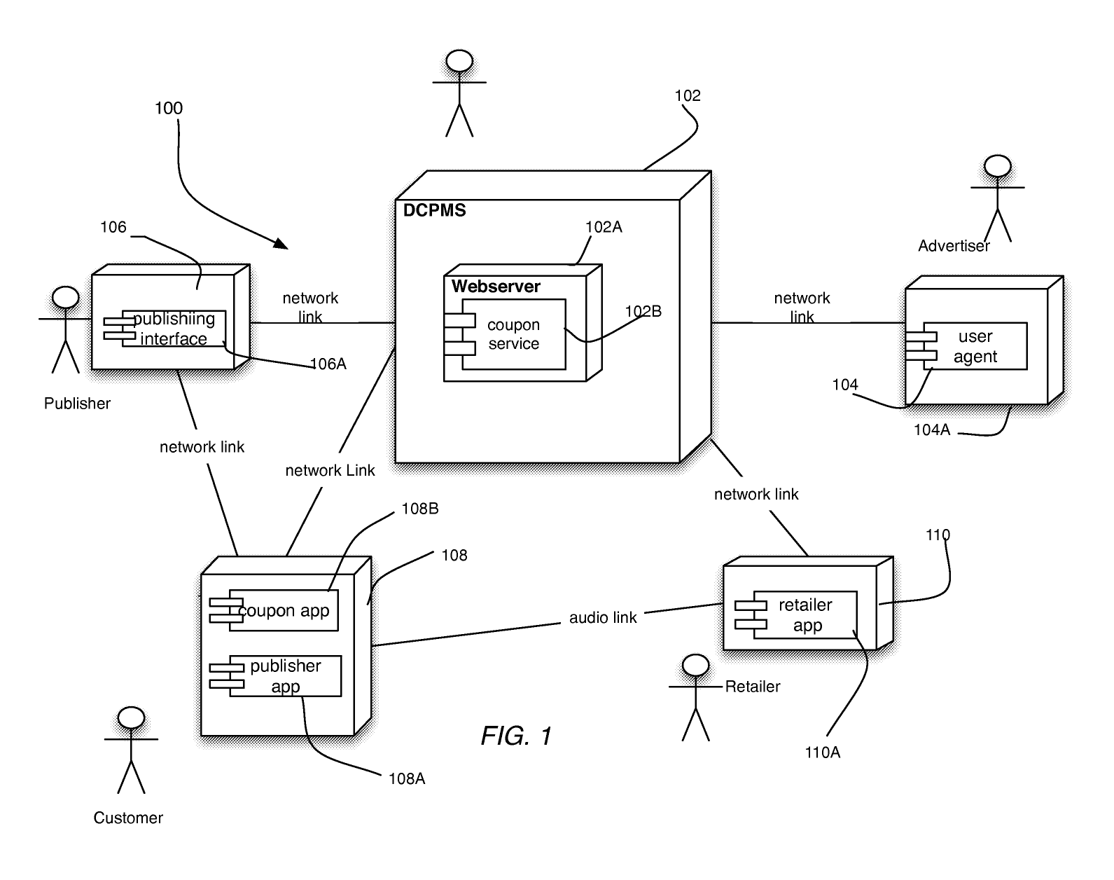

FIG. 1 shows a deployment scenario 100 in accordance with one embodiment of the invention. Referring to FIG. 1 a Digital Coupon Personalization and Management System (DCPMS) 102 includes a server component 102A which implements a Coupon Service (CS) 102B. The CS 102B is under control of a Coupon Service Provider (CSP) A plurality of advertiser nodes 104 each equipped with an appropriate user agent (browser) 104A are communicatively coupled to the DCPMS 102 by means of a network link 112. In one embodiment, each advertiser node 104 may include a computing device such as a laptop or PC, and the network link 112 may comprise the Internet. Each advertiser node 104 represent an Advertiser who uses the CS to generate coupons on its behalf, as will be explained.

The DCPMS 102 may also be communicatively coupled with plurality of publisher nodes 106 by means of a network link 112. Each publisher node 106 represent a computing device such as a PC and includes a publishing interface 106A, which represent the mechanism whereby a Publisher is able to publish media on a customer node 108 for viewing by a Customer. Examples of Publishers includes CNN, Facebook, YouTube, etc.

The customer node 108 represents a customer device such as smartphone or tablet PC. In one embodiment, the customer node 108 may include a publisher app 108A and a coupon app 108B. The publisher app 108A may be configured to receive media content from a Publisher, as will be described more fully later. The media content may include a personalized coupon generated by the DCPMS 102.

Finally, the deployment scenario 100 also includes a retailer node 110 which represents retailer. In one embodiment, the customer node 108 communicates with the retailer node 110 via an audio link 114.

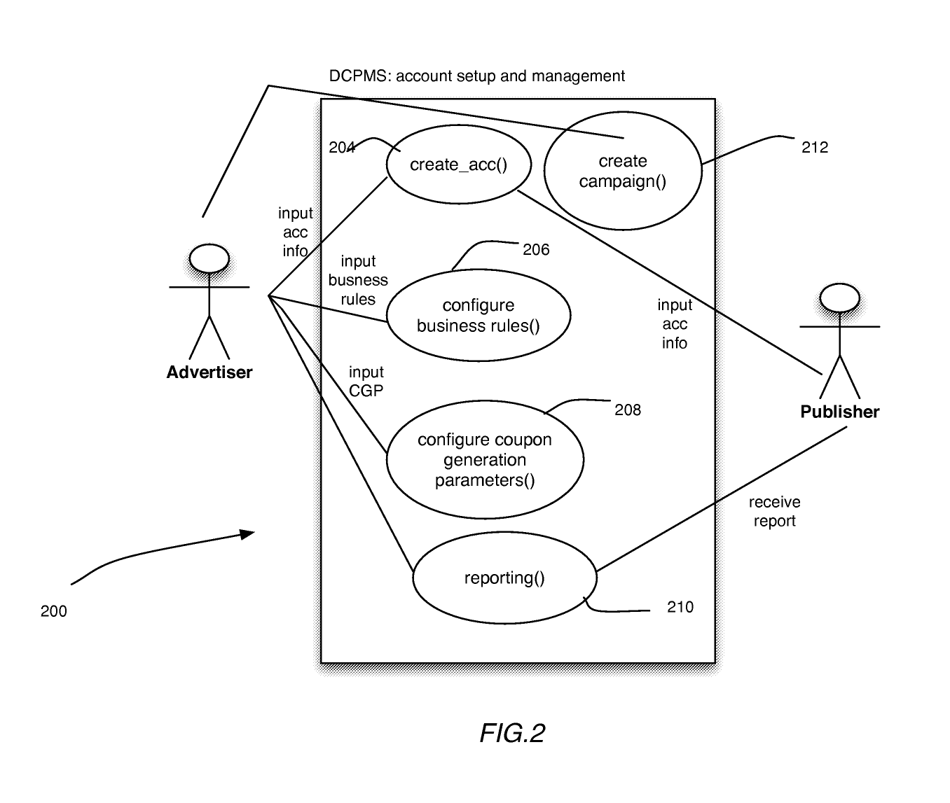

FIG. 2 shows use cases 200 for the DCPMS 102, in accordance with one embodiment of the invention. As will be seen, the DCPMS 102 supports a create_account ( ) function 202 which allows an Advertiser and a Publisher to create user accounts on the DCPMS 102. A configure_business_rules ( ) function 208 allows an Advertiser to provision business rules and objectives in the DCPMS 102. The business rules and objectives may be used to generate highly personalized coupons for publishing to particular customers, as will be described. The use cases 200 also includes a configure_coupon_generation_parameters ( ) process 210 whereby an advertiser configures coupon generation parameters which are used to generate personalized coupons. Examples of coupon generation parameters include the following:
(a) Demographic data;
(b) Geographic data;
(c) Offer size for a coupon offer. This may be specified in the terms of a minimum offer size and a maximum offer size;
(d) The particular medium for which a coupon needs to be generated. Examples of media include video content, banner ads, and printed ads.
(e) Publisher. Examples of publishers includes Facebook, YouTube, CNN etc.;
(f) Context for the coupon. Examples of contexts includes sports, politics, science, business, lifestyle, etc.;
(g) Psycho-graphic information comprising values, opinions, attributes, interests, and lifestyles associated with a target demographic group.

Finally, the use cases 200 include a reporting function 212 whereby reports are generated for Advertisers and Publishers.

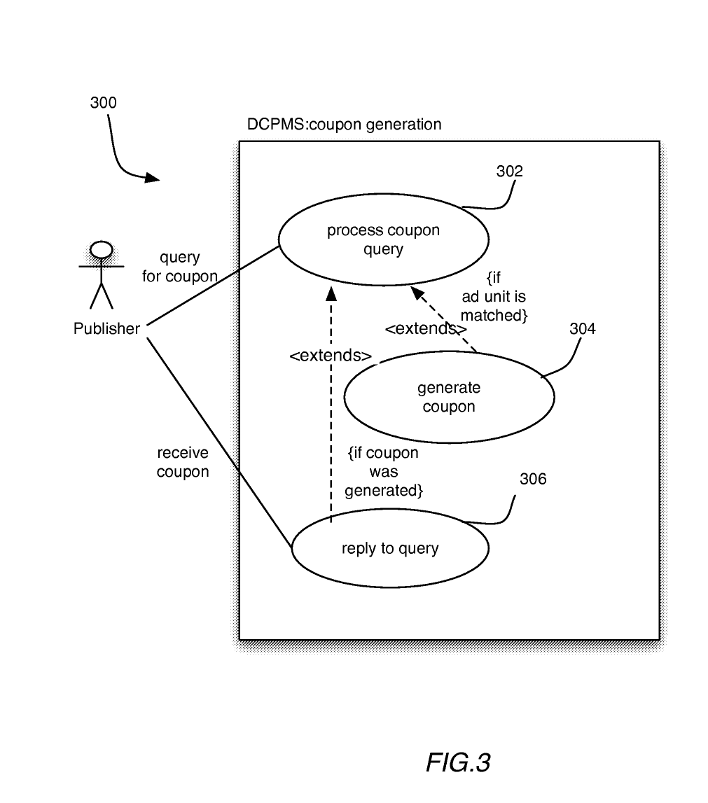

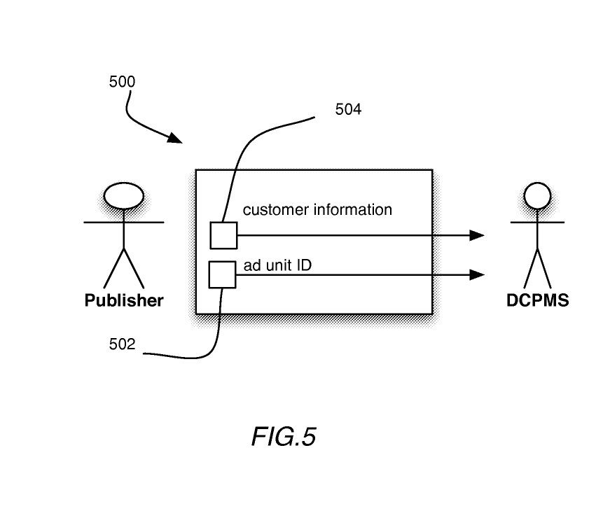

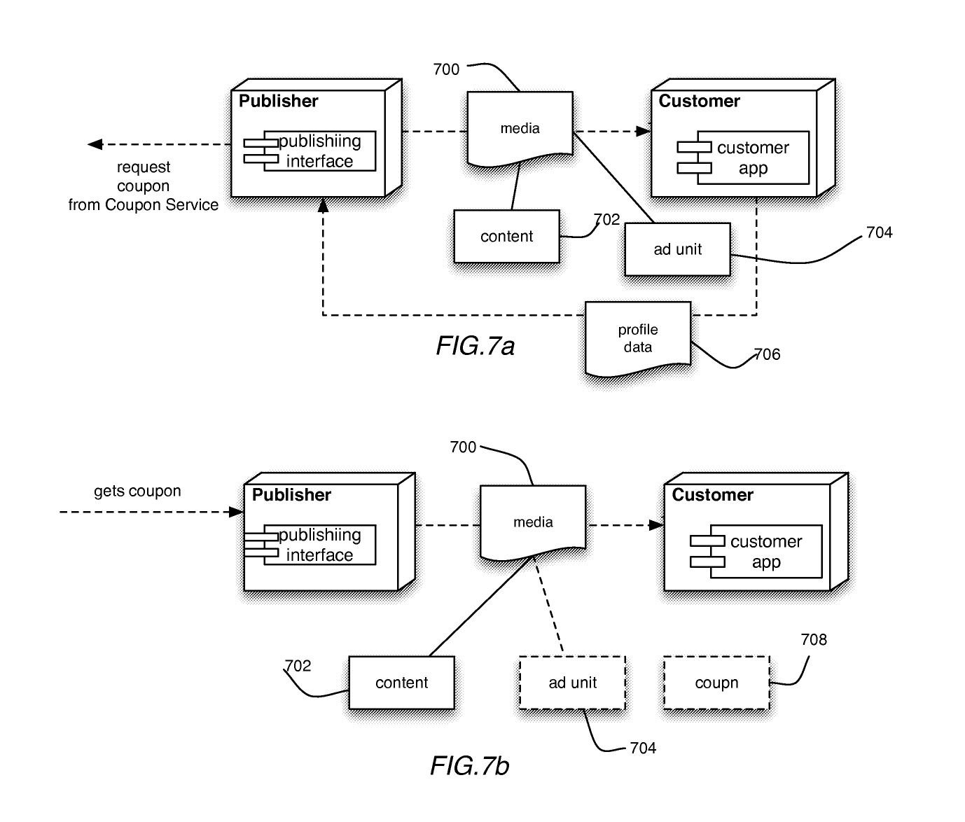

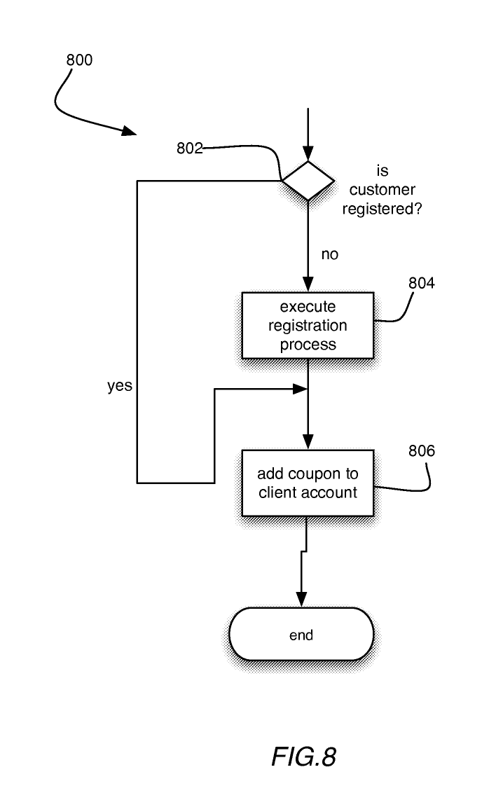

Referring now to FIG. 3 of the drawings, there is shown use cases 300 for coupon generation, in accordance with one embodiment of the invention. In terms of the use cases 300, a Publisher sends a query Q1 to the DCPMS 102. The query Q1 is a request for a coupon. Generally, at the time of sending the query Q1, the Publisher is already publishing content to a customer and is the further, typically displaying an advertisement unit (ad unit) in association with the content. This can be seen in FIG. 7a, which shows media 700 being published on a customer node 108, wherein the media 700 includes content 702 and an ad unit 704. FIG. 5 shows the elements of the query Q1, in one embodiment. As will be seen, Q1 includes customer information 500 and an ad unit id 502. The ad unit id 502 corresponds to the ad unit being shown to the Customer. The customer information corresponds to profile information/data 706 (see FIG. 8) about the Customer. The profile data 706 is collected from the Customer node 108 by the Publisher and includes that customer's browsing behavior and information about the customer device itself.

Responsive to receiving the coupon query Q1, the DCPMS 102 executes a process coupon query block 304. Under this block, the DCPMS 102 attempts to match the ad unit id in the coupon query Q1 in an ad unit list. The ad unit list is provisioned by an Advertiser and is basically a listing of ad units for which coupons must be generated by DCPMS 102. Thus, under the process 304, if the ad unit id is matched then a generate coupon function 306 is executed. Under this process, a personalized coupon is generated based on the coupon configuration parameters and based on machine learning techniques.

The use cases 300 also include a reply to query function 308 wherein the DCPMS 102 replies to the query Q1 by returning a coupon to the publisher 302 or a reply indicating that no coupon is available for the particular ad unit associated with the coupon request Q1. FIG. 7B shows the media 700 that is published on a customer node 108 as updated by the Publisher to include a coupon 708.

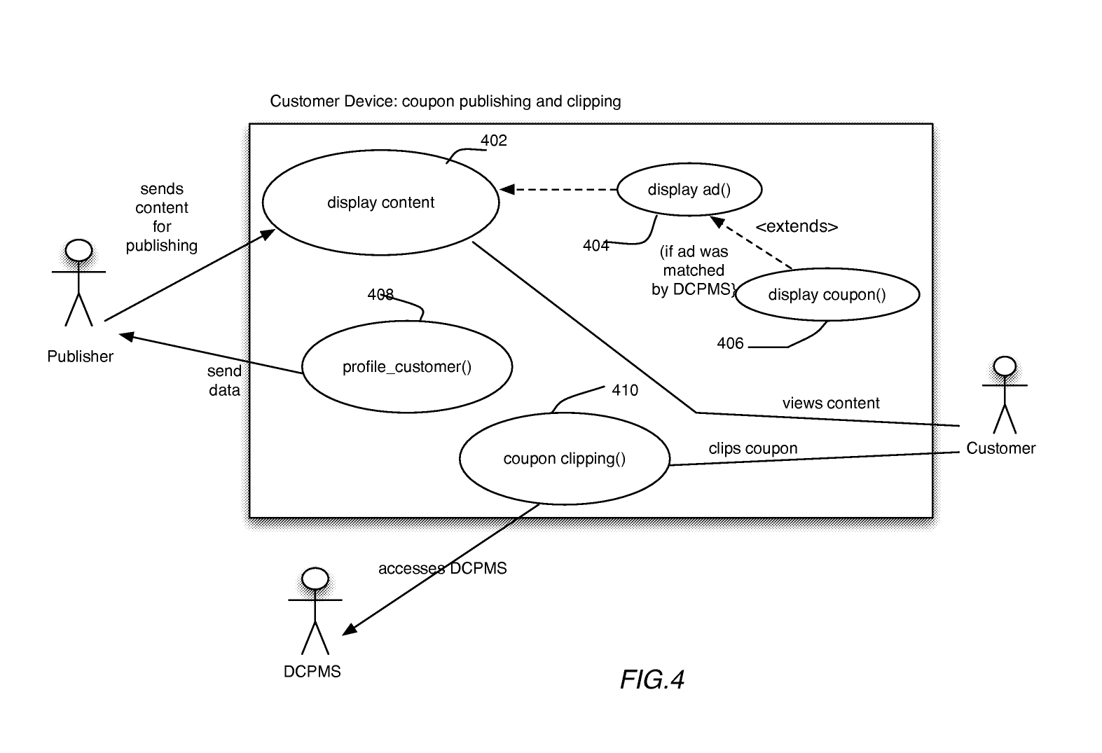

FIG. 4 shows use cases 400 for coupon displaying and clipping on the customer node 402, in accordance with one embodiment of the invention. As will be seen, the customer node 108 is configured to display content by executing a display content function 402. The display content function 402 may be extended to include a display ad function 404 which in turn may be extended to include a display coupon function 406 if the ad unit associated with the ad being displayed is match by the DCPMS 102, as described earlier. A profile customer ( ) function 408 collects profile information for a customer which is transmitted to the Publisher. The use cases 400 also includes a coupon clipping ( ) function 410. Under the coupon clipping function 410, a Customer performs a ‘clipping action’ in relation to a coupon. For example, in one embodiment, the clipping action may include selection of a clipping button associated with the coupon. Responsive to said clipping action, the coupon clipping function 410 generates a coupon clipping notification and transmits it to the DCPMS 102.

Referring now to FIG. 8 of the drawings, there is shown a process 800 executed on the DCPMS 102 responsive to receiving a coupon clipping notification. At block 802, a check is made to determine if the customer is a registered customer. In one embodiment this step includes validating customer credentials included in the coupon clipping notification. If it is determined that the customer was not registered, then at block 804, a registration process is executed in order to register the customer. This process may include redirecting a customer to a registration page in order for the customer to input registration information. At block 806, the coupon identified by the coupon id in the coupon clipping notification is added to the customer's account. At this point, the DCPMS 102 may inform the Publisher that the coupon has been clipped, in which case the publisher may instruct a browser being used by the customer node 108 to view the coupon to stop displaying the coupon.

In the case where a Customer is using the coupon app 108B to view the published content, the coupon app 108B includes logic to stop showing the coupon as soon as the coupon clipping action is performed. Thus, a seamless coupon clipping experience is facilitated.

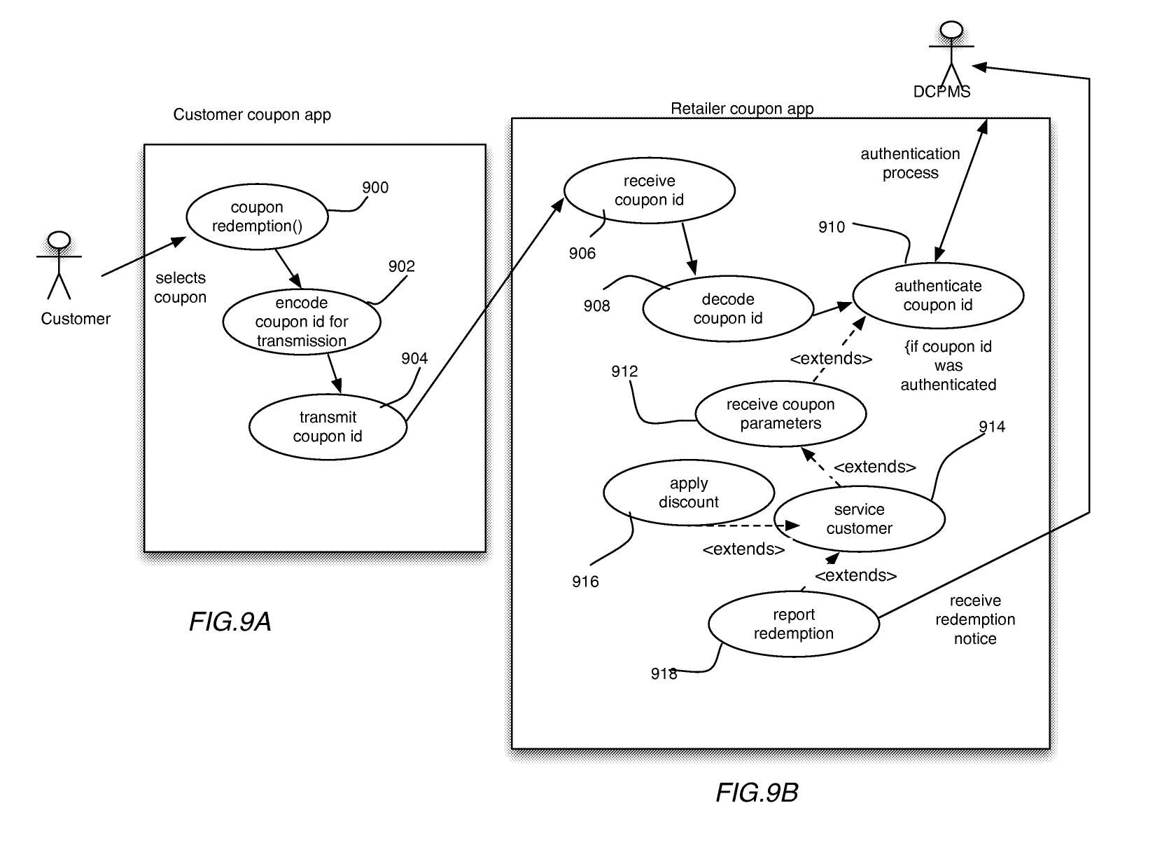

Referring now to FIG. 9A of the drawings, there is shown a use case for coupon redemption by a Customer. As will be seen, a coupon redemption) function 900 includes a process 902 for encoding a coupon for transmission, and a process 904 for transmitting said encoded coupon to a retailer node. In one embodiment, the process 902 for encoding the coupon for transmission encodes the coupon as an audio signal which is then transmitted via a speaker associated with the customer node 108. The retailer node 110 then uses a microphone to detect the audio encoding. FIG. 9B also shows a use case for the retailer coupon app 110A to redeem a coupon, in accordance with one embodiment. Referring to FIG. 9B, process 906 comprises a receive coupon id ( ) function whereby a microphone of the retailer node 110 is used to listen for the coupon transmission from the customer node 108. A decode coupon id ( ) process 908 decodes the audio signal in order to extract the coupon id. An authenticate coupon id ( ) process 910 includes transmission of the coupon id to the DCPMS 102 by the retailer coupon app for authentication. The DCPMS 102 authenticates the coupon id and returns coupon parameters associated with the coupon id that was authenticated. The retailer coupon app then executes a receive coupon parameters( ) function 912 to receive the coupon parameters from the DCPMS 102. A service customer ( ) function 914 includes servicing the customer by providing the goods and/or services associated with the coupon. A apply discount ( ) function 916 extends the service customer ( ) function 914 to apply the discount indicated in the coupon to the transaction with the customer. A report redemption ( ) function 918 includes operations to report any coupon redemption to the DCPMS 102.

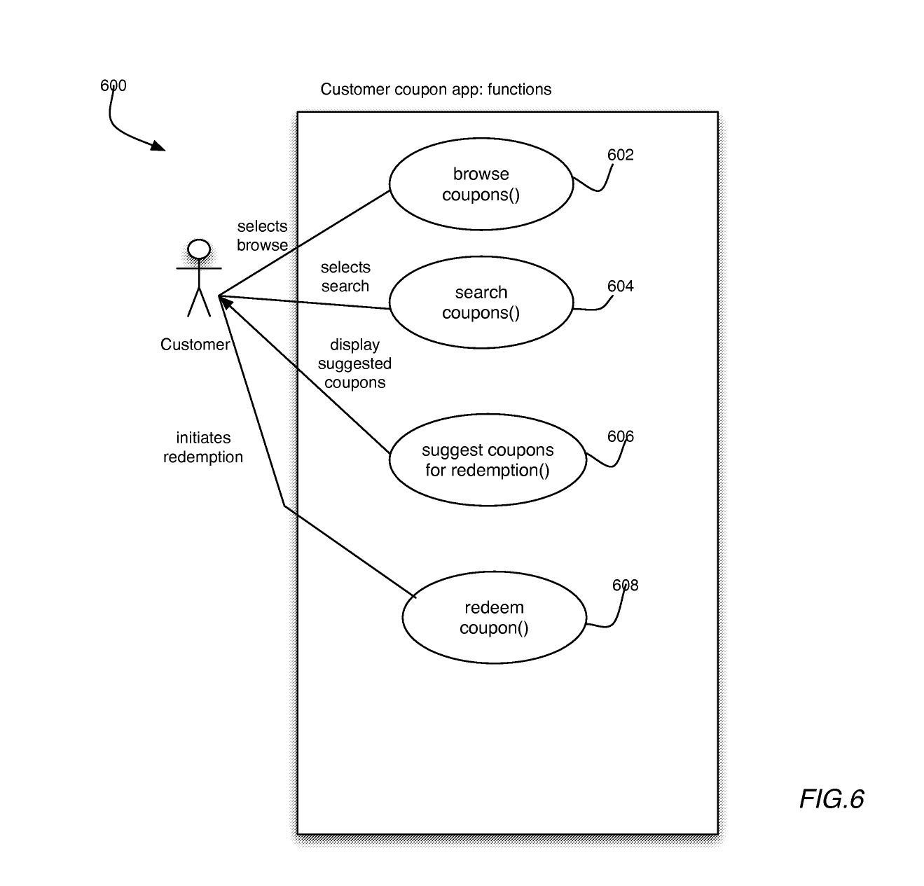

Referring now to FIG. 6 of the drawings, use cases 600 are associated with the coupon app 108B. As will be seen, the use cases 600 may include a browse coupons ( ) function 602. This function allows a Customer to browse previously clipped coupons. A search coupon ( ) function 604 allows the Customer to search for particular coupons based on search criteria. A suggest coupon for redemption ( ) function 608 implements functionality to proactively suggest coupons for redemption to a Customer. For example, in one embodiment based on the location, the Customer may be shown coupons that are only available for redemption at that particular location. Finally, the use case 600 includes a redeem coupon function ( ) 610, whereby the Customer may redeem a selected coupon, as has been described above.

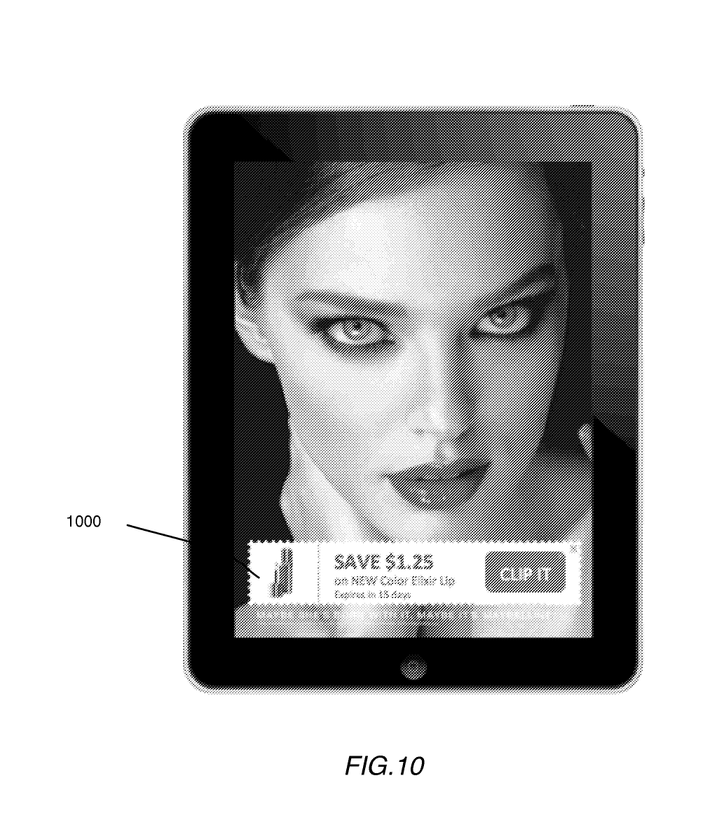

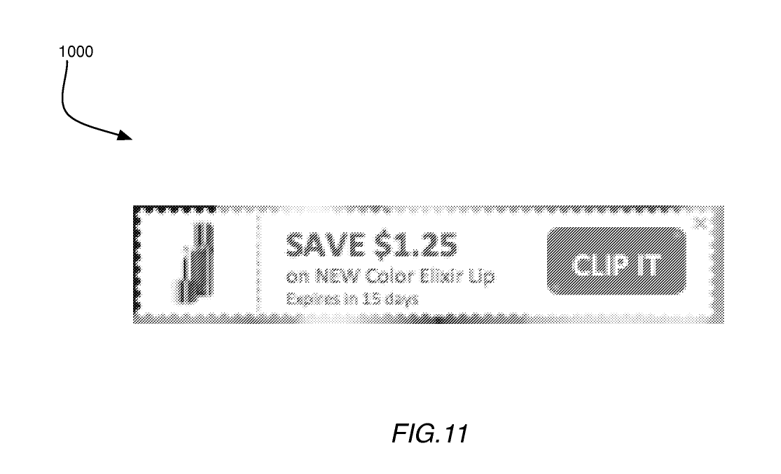

Referring now to FIG. 10 of the drawings, there is shown a coupon 1000 which is published in association with an advertisement for women's' lipstick. The coupon 1000 is shown in magnified view FIG. 11 of the drawings. As will be seen, the coupon 1000 includes a discount of $1.25, and a coupon expiration, which is set to 15 days. Further, the coupon 1000 includes a ‘clip it button’. This button may be used to clip the coupon 1000 in accordance with the techniques disclosed herein.

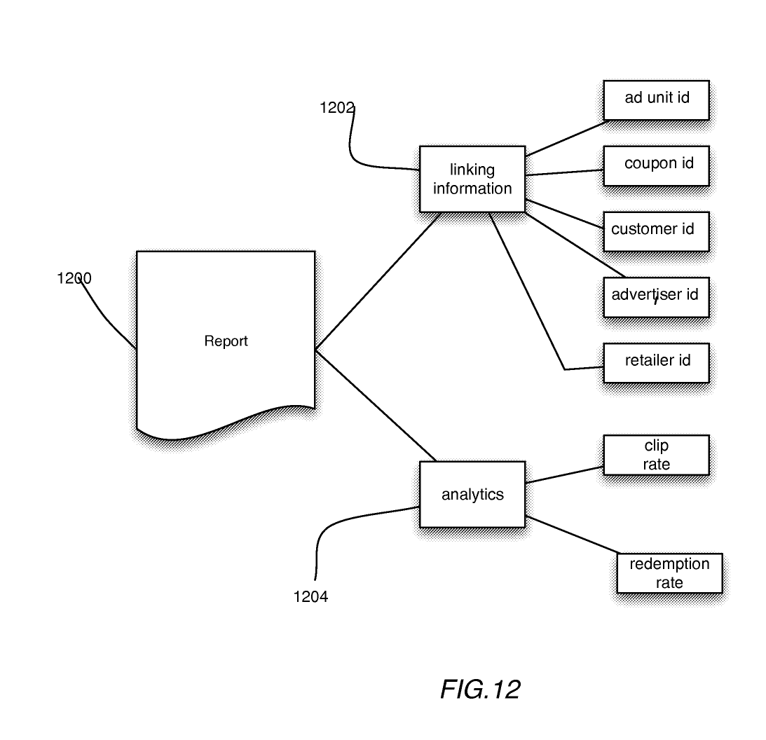

FIG. 12 shows a report 1200 that may be generated for an Advertiser, in accordance with one embodiment. The report 1200 includes linking information 1202 to link ad unit id, coupon id, customer id, advertiser id, and retailer id. Report 1200 also includes an analytics component 1204 which may provide detailed analysis on a coupon's clip rate and its redemption rate. The coupon clip rate and redemption rate may be used to optimize a coupon campaign. As has been mentioned, machine running techniques are used to generate a coupon in a dynamic fashion. For example, coupon may be configured to have a certain clip rate and a certain redemption. If a clip rate for a coupon is too high the system may dynamically reduce the discount associated with the coupon in order to throttle or scale back the redemption rate. Alternatively, if the coupon clip rate is too low, then the DCPM 102 S may dynamically increase the discount associated with the coupon in order to achieve the desired clip rate. Likewise, a coupons redemptions rate may be used to dynamically scale the offer sized associated with the coupon in order to achieve a desirable redemption rate.

Reducing Stock Outs

In emerging markets, CPG companies use salesman to regularly visit traditional stores to identify low inventory items and take orders. This system is inefficient as only a small percentage of visited stores have low inventory/stock outs and are ready to place orders. Consequently, most salesman store visits result in no sales.

In one embodiment, there is provided a method to detect stock outs without manual inspection by CPG salesforce.

Preventing Coupon Redemption Fraud

It sometimes is the case that merchants/store owners are involved in what is termed “coupon redemption fraud”, a condition that occurs when a merchant sells the product of one manufacturer but fraudulently reports that a coupon of another manufacturer was redeemed, usually a competitor, for redemption. For example, the merchant my sell a “Coke” to a customer, but may report that a “Pepsi” coupon was redeemed. Such fraudulent behavior may be motivated by various reason including that the product actually sold my yield greater margins to the merchant. In some cases “miss redemptions” may occur. The latter is the condition where a merchant reports a coupon redemption in error. For e.g., the merchant might report that a Coke coupon was redeemed, whereas the event triggering the coupon redemption was in fact the sale of a Pepsi.

In one embodiment, the invention addresses the issues of coupon redemption fraud and miss redemptions as will not be described. For this embodiment, coupons are encoded in a special code or mark that is printed on product packaging. In particular, the coupon id of each coupon is encoded in the special code. Preferably, the code is printed on the inside of the packaging and thus in inaccessible save for opening the packaging. The idea is that once a product is purchased, the redemption of the coupon takes place at the home of the customer. The redemption involves the customer scanning the coupon with the coupon app 108B. The coupon app 108B is configured to transmit the coupon id associated with the coupon to the DCPMS. The aforesaid coupon redemption may trigger various benefits for the customer. For example, the DCPMS may credit points (akin to airline miles) to the customer which may be redeemable for other products or used to procure products and services at a discount. Because, this embodiment places the responsibility of reporting coupon redemptions in the hands of the customer, the possibility of coupon redemption fraud is reduced. Moreover, because the coupon id is scanned, there is no chance of coupon miss redemption. For added protection against fraud, in one embodiment, the coupon app 108B uses location tracking to determine the location of the customer. If the location of the customer is identified to be not at their home, then the function to scan a coupon is disabled until such time it is determined that the customer is at home, in which case it is enabled. In the customer, disable location tracking on his/her mobile device, then the coupon app 108B may be configured to disable the coupon scanning function until such time that location tracking is enabled.

Option 1—Passive Detections

From time to time, a consumer may not be able to redeem a coupon due to the fact that the product associated with coupon may be out of stock a particular store. In one embodiment, the coupon app 108B provides the customer with the capability to report a failed coupon redemption event For example, each coupon displayed in the coupon app 108B may have a “button” to report a failed coupon redemption event associated with the coupon. Customer activation of the button may trigger prompts sent to the user to obtain more information about the failed coupon redemption. The prompts may be configured to solicit information on the store at which the attempt to redeem the coupon was made, and the time of the attempted redemption from the customer. The reporting of the failed coupon redemption event is to the DCPMS. In one embodiment, the DCPMS may be configured to store each failed coupon redemption event and to route it to a corresponding product manufacturer salesforce for use as an inference of a product stock out at a store. In one embodiment, the customer may be incentivized to report a stock out in the manner described above through the provision of a reward to the customer for said report. The reward may take the form of point, products, discounts, etc.

Option 2—Active Detection

In one embodiment, to proactively detect stock outs of a particular SKU in a particular store, the DCPMS may be configured to proactively send out a coupon/promotional offer for that SKU to customers near or inside the store. The determination of whether a customer is “near of inside the store” is made based on location services associated with the mobile device of the customer. The coupon may provide a larger than usual discount and/or short expiration time (for example 6 hours) to encourage immediate redemption of the coupon. Since only one redemption per store per day is necessary to improve detection of stock out SKUs, the cost of stock-out detection by distributing promotional offers to consumers is likely to be less than the time of a salesman visiting the store.

Shopping List and Targeted Coupons

It is known to provide apps to consumers to facilitate the keeping of shopping lists. In its essence, a shopping list is just a list of items that a customer wishes to purchase. Heretofore, the problem with shopping lists is that it does not incentivize the keeping of such lists nor does it penalize the non-keeping of these lists. In one embodiment, the coupon app 108B may be configured to allow a consumer to keep a shopping list in a manner similar to existing shopping list apps. The coupon app 108B reports the items in the shopping list to the DCPMS. The DCPMS may be configured to aggregate the items in shopping lists of multiple consumers to create data on items sought, quantity, etc. Moreover, the information may be organized by locality or zip code. The DCPMS may share this information with manufacturers to enable a more targeted coupon campaign. Thus, a manufacturer may gain insight of what products are in demand in what area to create a custom coupon based on factors such as available inventory, etc. to proactively generate a targeted coupon. In some cases, the information may be shared with a competing manufacturer to enable the competing manufacturer to induce sales of its product.

Advantageously, and one embodiment, a manufacturer made on a campaign to target particular consumers with certain coupons or promotional offers by leveraging the information in customers shopping lists, dynamically, and in real time. For example, the DCPMS may be configured to transmit network messages to a plurality of mobile devices of consumers that a provision with the coupon application. Various techniques may be used to identify a selection of consumers/mobile devices that the network messages are to be transmitted to. For example, in one embodiment a manufacturer may be interested in targeting consumers within a particular geographic area, for example consumers within a particular ZIP code. In order to identify consumers within a particular geographic area, and one embodiment, the DCPMS may be configured to periodically transmit location messages to the various mobile devices registered with it. In one embodiment, responsive to receipt of a location message by a mobile device provisioned with a coupon application, set coupon application may be configured to transmit location data to the DCPMS, thereby to enable the DCPMS to maintain real-time information on the location of the various mobile devices. Thus, in response to a manufacturer's query during a coupon duration process, the DCPMS can select only those mobile devices within a geographic area of interest to the manufacturer.

In order to obtain information on the products within the shopping lists of consumers within a particular geographic location, the DCPMS may be configured to transmit network messages to only those devices within said geographic location. Responsive to receiving said network messages, the devices within the geographic location in conjunction with their respective coupon applications, respond by sending messages to the DCPMS, said messages containing information on the products that are currently on the shopping lists of each consumer with the targeted geographic location.

In one embodiment, the DCPMS may be configured to aggregate the products on the shopping lists of the individual customers into an aggregated list. This aggregate list may be segmented into subsets, weighing each subset contains only those products of a particular manufacturer. Each subset of the aggregate list may be shared or made available to the relevant manufacturer so that the manufacturer can use this information targeting consumers with particular coupons or promotional offers. Thus, regardless of whether the coupon application is actually running on a particular mobile device or not, the DCPMS is always guaranteed to obtain information from said coupon application of the items on a shopping list maintained by said coupon application.

Advantageously, in one embodiment and network messages may be configured to, when received by a mobile device, to awaken the coupon application provisioned in said device and to cause transmission of a response message which includes relevant information from the shopping was maintained by said coupon application.

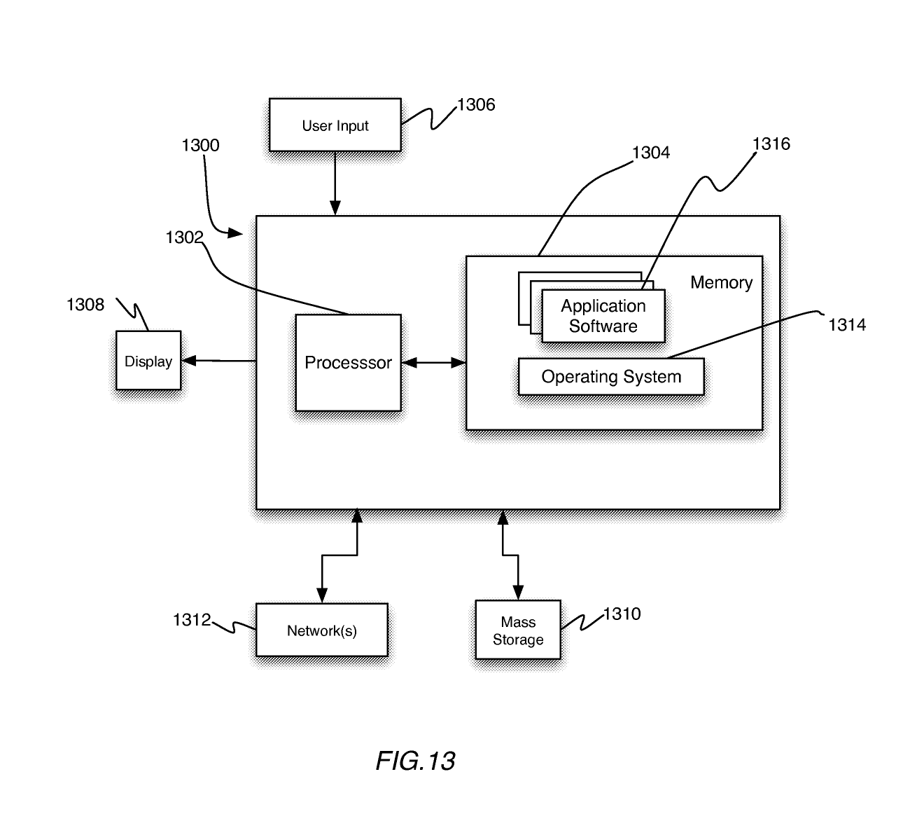

FIG. 13 shows an example of hardware 1300 that may be used to implement the DCPMS 102 in accordance with one embodiment. The hardware 1300 may include at least one processor 1302 coupled to a memory 1304. The processor 1302 may represent one or more processors (e.g., microprocessors), and the memory 1304 may represent random access memory (RAM) devices comprising a main storage of the hardware, as well as any supplemental levels of memory e.g., cache memories, non-volatile or back-up memories (e.g. programmable or flash memories), read-only memories, etc. In addition, the memory 1304 may be considered to include memory storage physically located elsewhere in the hardware, e.g. any cache memory in the processor 1302, as well as any storage capacity used as a virtual memory, e.g., as stored on a mass storage device.

The hardware also typically receives a number of inputs and outputs for communicating information externally. For interface with a user or operator, the hardware may include one or more user input output devices 1306 (e.g., a keyboard, mouse, etc.) and a display 1308. For additional storage, the hardware 1300 may also include one or more mass storage devices 410, e.g., a Universal Serial Bus (USB) or other removable disk drive, a hard disk drive, a Direct Access Storage Device (DASD), an optical drive (e.g. a Compact Disk (CD) drive, a Digital Versatile Disk (DVD) drive, etc.) and/or a USB drive, among others. Furthermore, the hardware may include an interface with one or more networks 1312 (e.g., a local area network (LAN), a wide area network (WAN), a wireless network, and/or the Internet among others) to permit the communication of information with other computers coupled to the networks. It should be appreciated that the hardware typically includes suitable analog and/or digital interfaces between the processor 1312 and each of the components, as is well known in the art.

The hardware 1300 operates under the control of an operating system 1314, and executes application software 1316 which includes various computer software applications, components, programs, objects, modules, etc. to perform the techniques described above.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

1. A method for a server to generate coupons, comprising:
provisioning each of a plurality of mobile devices with a coupon application, said coupon application having a capability to allow a customer to maintain a shopping list within the coupon application;
periodically sending a plurality of network messages, each to one of the plurality of said coupon applications via a network transmission to the mobile device on which said coupon application is provisioned, said message to trigger said coupon application to send at least one response message comprising items in the shopping list maintained in the coupon application;
aggregating the items listed in the response messages across coupon applications into an aggregated list;
performing a coupon generation process to generate at least one coupon, each for a selected item in the aggregated list; and
transmitting each coupon generated to a selected group of coupon applications via a network transmission to each mobile device on which one of the coupon applications from said selected group is installed.

2. The method of claim 1, further comprising performing a selection process to select the mobile devices to which the network messages are transmitted.

3. The method of claim 2, wherein said selection process is to select those mobile devices as a particular geographic area.

4. The method of claim 1, further comprising generating subsets of the aggregated list, wherein each subset comprises only those items associated with a particular manufacturer.

5. The method of claim 4, further comprising making each of the aggregated list available to the particular manufacturer associated therewith, and using the coupon generation process.

6. The method of claim 3, further comprising sending location messages to each of the plurality of mobile devices, responses to which mobile devices report their location to the server.

7. A system for generating coupons, comprising
periodically sending a plurality of network messages, each to one of a plurality of coupon applications via a network transmission to a mobile device on which said coupon application is provisioned, said message to trigger said coupon application to send at least one response message comprising items in a shopping list maintained in the coupon application;
aggregating the items listed in the response messages across coupon applications into an aggregated list;
performing a coupon generation process to generate at least one coupon, each for a selected item in the aggregated list; and
transmitting each coupon generated to a selected group of coupon applications via a network transmission to each mobile device on which one of the coupon applications from said selected group is installed.

8. The system of claim 7, when the service configured to perform a selection process to select the mobile devices to which the network messages are transmitted.

9. The system of claim 8, wherein said selection process is to select those mobile devices as a particular geographic area.

10. The system of claim 7, when the service configured to generate subsets of the aggregated list, wherein each subset comprises only those items associated with a particular manufacturer.

11. The system of claim 10, when the service configured to make each of the aggregated list available to the particular manufacturer associated therewith, and using the coupon generation process.

12. The system of claim 9, when the service configured to send location messages to each of the plurality of mobile devices, responses to which mobile devices report their location to the server.
